(19) United States
(12) Patent Application Publication
(10) Pub. No.: US 2011/0249960 A1
(43) Pub. Date: Oct. 13, 2011

(54) Heat Source Door For A Thermal Diffusion Chamber

(75) Inventors: Henry J. Poole, Ventura, CA (US); Mark R. Erickson, Newbury Park, CA (US); Nader Jamshidi, Newbury Park, CA (US); Aaron L. Dingus, Moorpark, CA (US); Arthur W. Custer, III, Ventura, CA (US)

(73) Assignee: POOLE VENTURA, INC., Oxnard, CA (US)

(21) Appl. No.: 13/016,511

(22) Filed: Jan. 28, 2011

(51) Int. Cl. F27D 11/00; F27D 1/18; B21D 53/02

(52) U.S. Cl. 392/408; 392/416; 29/890.03

(57) ABSTRACT

A frame supporting a containment chamber, the containment chamber is preferably configured to enclose and confine a process chamber. A heat source module is disposed between the containment chamber and the process chamber, while a collar communicates with the process chamber and is secured to the process chamber. Preferably, a heat source door is in fluidic communication with the process chamber, and includes at least a top hat section secured to a main body portion, an over center latch secured to the top hat section and interacting with the collar, the over center latch mitigates an inadvertent opening of the process chamber, and a lamp feed-through is preferably secured to the main body portion and supports a heat source device.

### FIELD OF THE INVENTION

The claimed invention relates to the field of thermal diffusion chamber equipment and methods of making thermal diffusion chambers for the production of solar energy panels, and more particularly to structures and methods of providing heat to an internal cavity of a process chamber of the thermal diffusion chamber via at least a heat source door.

### BACKGROUND

A form of solar energy production relies on solar panels, which in turn rely on the diffusion of select materials onto a substrate. In one example, glass is used as the substrate, which is exposed to a gaseous selenide species to form a copper, indium and selenide containing film on the substrate. The gaseous selenide species is known to be toxic to humans, and require temperatures in excess of 510 degrees Celsius to attain diffusion.

As such, the supply of thermal energy into the process chamber, to hold temperature as close to constant during critical steps in the diffusion process, can greatly improve the operation and production output of thermal chambers used in providing substrates a copper, indium and selenide containing film diffused within them.

Accordingly, there is a continuing need for improved mechanisms and methods of providing thermal energy to the process chamber of thermal diffusion chambers.

### SUMMARY OF THE INVENTION

The present disclosure relates to thermal diffusion chambers and in particular to a heat source door and methods for providing heat to a process chamber of a thermal diffusion chamber via at least the heat source door.

In accordance with various exemplary embodiments, a frame supporting a containment chamber is constructed. The containment chamber is configured to support, enclose, and confine a process chamber confined within the containment chamber. In the exemplary embodiment, a heat source module is disposed between the containment chamber and the process chamber, and a collar in fluid communication with an interior cavity of the process chamber is secured to the containment chamber. In the exemplary embodiment, a heat source door in fluidic communication with the interior cavity of the process chamber. Preferably, the heat source door includes at least a top hat section secured to a main body portion, an over center latch secured to the top hat section and interacting with the collar, the over center latch mitigates an inadvertent opening of the process chamber, and a lamp feed-through secured to the main body portion and supports a heat source device.

In an alternate exemplary embodiment, a method of forming a thermal diffusion chamber includes at least the steps of providing a frame, supporting a containment chamber on the frame, and disposing a heat source module within the containment chamber. With the heat source module in position, a process chamber is enclosed, confined, and supported within the heat source module, which forms a thermal regulation cavity located between the heat source module and the process chamber. With the thermal regulation cavity formed, a next step involves securing a collar to the process chamber, and securing at least one heat source door to the collar and in fluidic communication with the process chamber. The heat source door preferably includes at least a top hat section secured to a main body portion, an over center latch secured to the top hat section and interacting with the collar, the over center latch mitigates an inadvertent opening of the process chamber, and a lamp feed-through secured to the main body portion and supporting a heat source device.

The method preferably further includes the steps of securing a lamp feed-through weldment to the main body portion, advancing a gland nut onto the weldment, positioning a gland collar responsive to the gland nut adjacent the gland nut, disposing a compression ring between the weldment and the gland collar, and compressing a seal member disposed between the compression ring and the weldment interacting with the heat source device to form a seal in response to a compressive load being applied to the seal member by the compression ring.

These and various other features and advantages that characterize the claimed invention will be apparent upon reading the following detailed description and upon review of the associated drawings.

### BRIEF DESCRIPTION OF THE DRAWINGS

FIG. 1 displays an orthogonal projection, with partial cut-away, of an exemplary embodiment of a thermal diffusion chamber of the claimed invention.

FIG. 2 provides a partial cut-away orthogonal projection of an exemplary heat source door and collar of the thermal diffusion chamber of FIG. 1.

FIG. 3 shows a back side orthogonal projection of the exemplary heat source door of FIG. 2.

FIG. 4 illustrates a front side orthogonal projection of the exemplary heat source door of FIG. 2.

FIG. 5 provides a partial cut-away front side orthogonal projection of the exemplary heat source door of FIG. 2.

FIG. 6 displays a view in elevation of a lamp feed-through of the exemplary heat source door of FIG. 2.

FIG. 7 shows a cross-section view in elevation of a lamp feed-through of the exemplary heat source door of FIG. 6.

FIG. 8 depicts a back side orthogonal projection showing a plurality of lamps used as the heat source of the exemplary heat source door of FIG. 2.

FIG. 9 provides a back side orthogonal projection of a diffusion and radiation reflection plate assembly of the exemplary heat source door of FIG. 2.

FIG. 10 generally illustrates a flow chart of a method of forming an exemplary embodiment of the thermal diffusion chamber of FIG. 1.

### DETAILED DESCRIPTION OF AN EXEMPLARY EMBODIMENT OF THE DRAWINGS

Reference will now be made in detail to one or more examples of various embodiments of the present invention depicted in the figures. Each example is provided by way of explanation of the various embodiments of the present invention, and not meant as a limitation of the invention. For example, features illustrated or described as part of one embodiment may be used with another embodiment to yield still a different embodiment. Other modifications and variations to the described embodiments are also contemplated within the scope and spirit of the claimed invention.

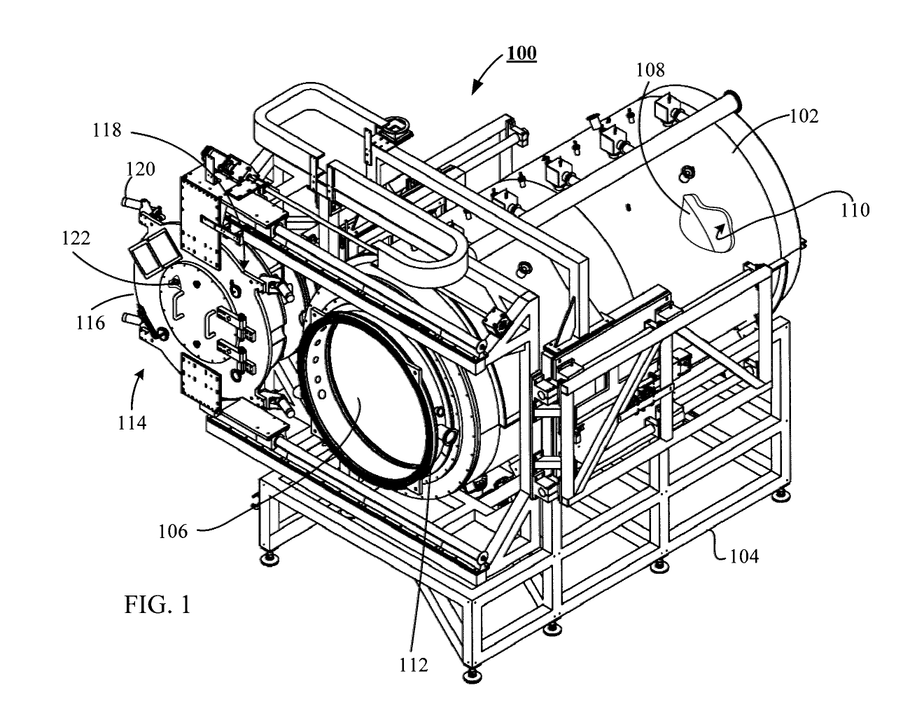

Turning to the drawings, FIG. 1 displays an exemplary thermal diffusion chamber 100 which includes at least a containment chamber 102 supported by a frame 104, which in turn supports a process chamber 106. Preferably the exemplary thermal diffusion chamber 100 further includes a heat source module 108 disposed between the process chamber 106 and the containment chamber 102, and a thermal regulation cavity 110 formed between the process chamber 106 and the heat source module 108. FIG. 1 further shows a collar 112 communicating with the process chamber 106 and secured to the containment chamber 102, and a heat source door 114 in fluidic communication with the process chamber 106 during an operating mode of the thermal diffusion chamber 100. Preferably, the heat source door 114 includes at least a top hat section 116 secured to a main body portion 118, an over center latch 120 secured to the top hat section 116 and interacting with the collar 112, and a lamp feed-through 122 secured to the main body portion 118.

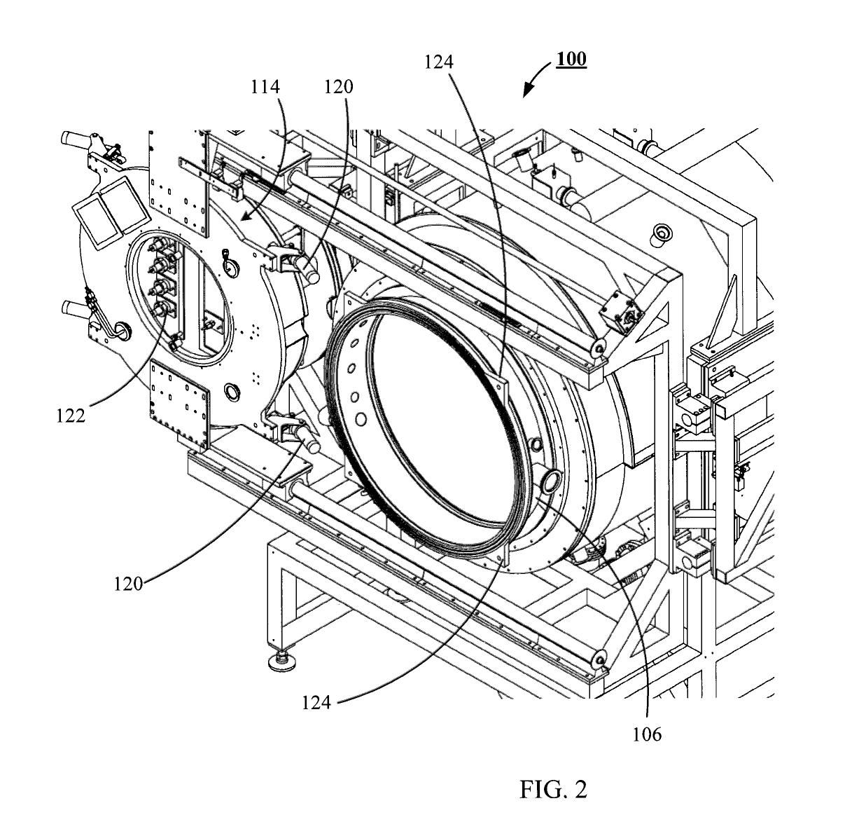

FIG. 2 shows the collar 112 provides a plurality of latch stays 124 which interact with corresponding over center latches 120 of the heat source door 114 to mitigate an inadvertent opening of the process chamber 106 during an operating mode of the thermal diffusion chamber 100.

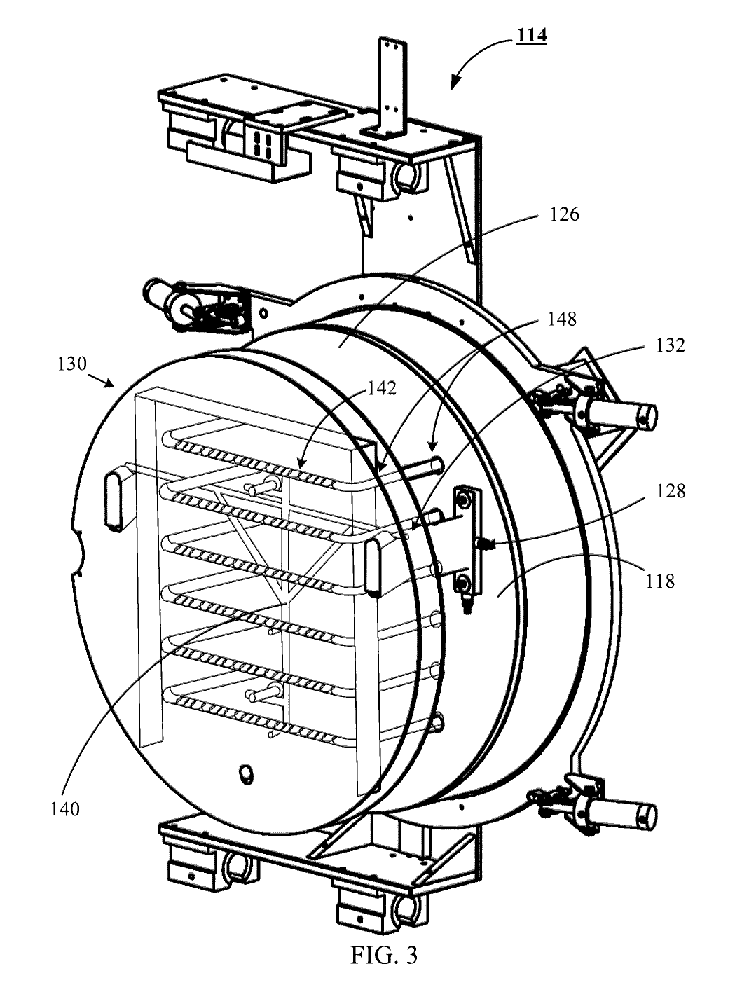

FIG. 3 provides a more detailed depiction of the heat source door 114. Preferably, the heat source door 114 includes a face plate 126 secured to the main body portion 118, and the lamp support 128 secured to the face plate 126. As shown by FIG. 3, the heat source door 114 further includes a thermal dispersion assembly 130, while the lamp support 128 provides a plurality in alignment notches 132 upon which the thermal dispersion assembly 130 is aligned and rests during operational modes of the thermal diffusion chamber 100.

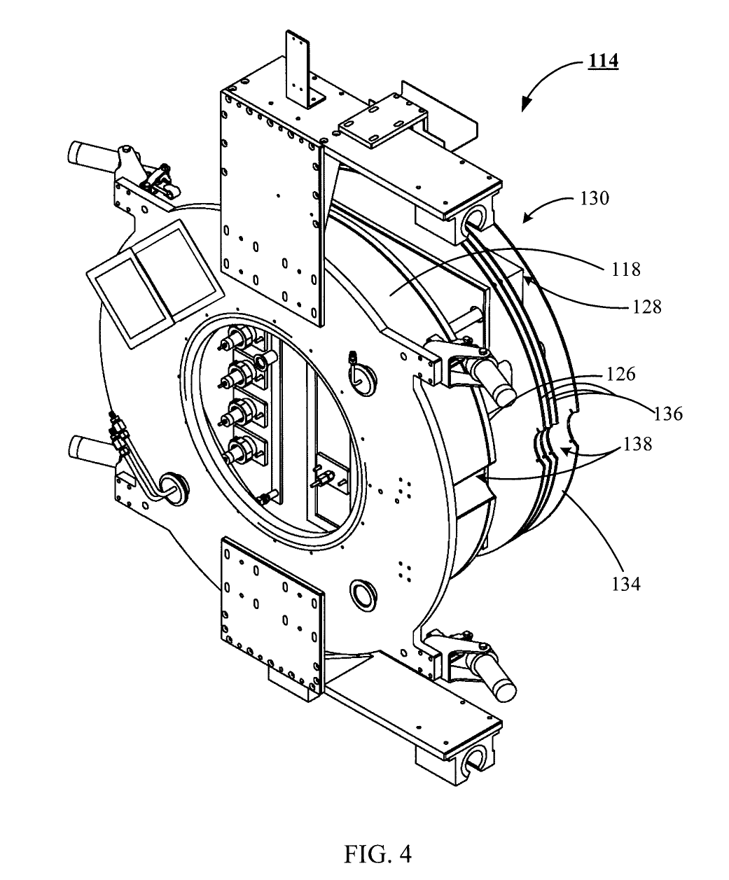

FIG. 4 shows the thermal dispersion assembly 130 of the heat source door 114 includes at least a diffuser plate 134 adjacent a plurality of radiation reflection plates 136. The diffuser plate 134 and a plurality of radiation reflection plates 136 are held in alignment by the lamp support 128. In a preferred exemplary embodiment, the main body portion 118, the face plate 126, and the thermal dispersion assembly 130 provide an instrument pass through a notch 138 for use in passing instrumentation from the exterior of the process chamber 106, of FIG. 1, to the interior of the process chamber 106.

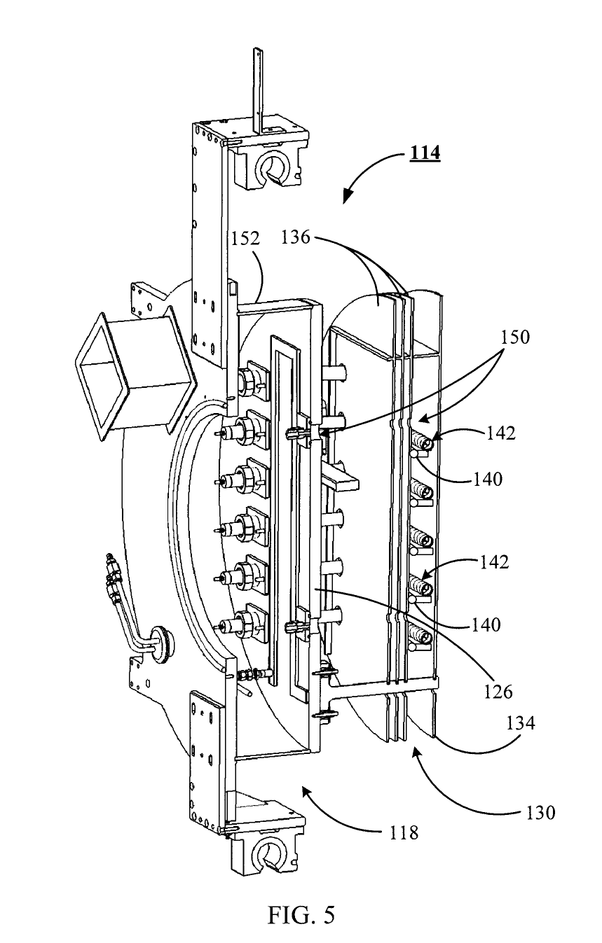

Returning to FIG. 3, shown therein is a lamp support tree 140 supported by the lamp support 128. As shown by FIG. 5, the lamp support tree 140 provides a means of aligning and supporting a plurality of lamps 142. FIG. 5 further shows that in an exemplary environment of the heat source door 114, the thermal dispersion assembly 130 preferably includes the diffuser plate 134 and the plurality of radiation reflection plates 136 with the plurality of lamps 142 disposed between the diffuser plate 134 and a first of the plurality of radiation reflection plates 136. Again returning to FIG. 3, as shown therein, to accommodate the placement of the plurality of lamps 142, both the face plate 126 and the plurality of radiation reflection plates 136 each provide a lamp pass-thru aperture 148, while FIG. 5 shows that both the face plate 126 and the plurality of radiation reflection plates 136 each provide a thermal sensor aperture 150.

In a preferred exemplary embodiment shown by FIG. 5, the main body portion 118 includes a stand-off 152 secured to the top hat section 116, and the face plate 126 is secured to the stand-off 152. Preferably, the thermal dispersion assembly 130 is configured to direct the thermal energy developed by the plurality of lamps 142 into the process chamber 106, of FIG. 1, and minimize the amount of radiant energy experienced by the face plate 126.

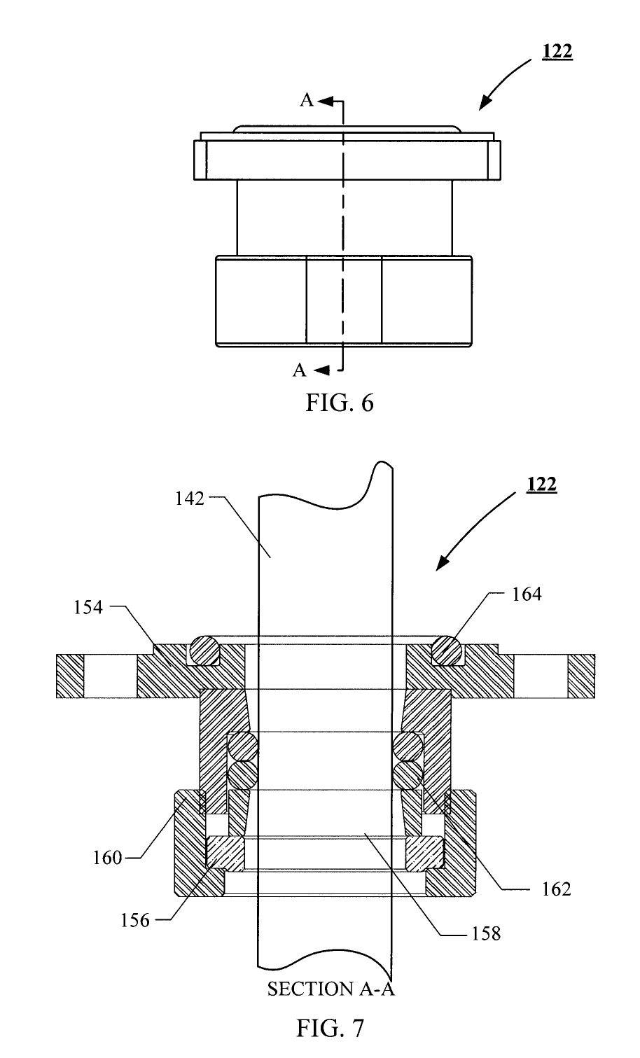

FIGS. 6 and 7 provide a more detailed view of the lamp feed-through 122. In a preferred embodiment, the lamp feed-through 122 includes at least a lamp feed-through weldment 154 secured to the face plate 126, of FIG. 1. The lamp feed-through 122 further preferably includes at least a gland nut 156 communicating with the weldment 154, a gland collar 158 responsive to the gland nut 156, a compression ring 160 disposed between the weldment 154 and the gland collar 158. FIGS. 6 and 7 further shows that the lamp feed-through 122 includes at least a seal member 162 disposed between the compression ring 160 and the weldment 154, and a second seal member 164. Preferably, the seal member 162 interacts with the heat source device 142 to form a seal there between in response to a compressive load being applied to the seal member 162 by the compression ring 160, while the second seal member 164 forms a seal between the face plate 126, of FIG. 5, and the weldment 154.

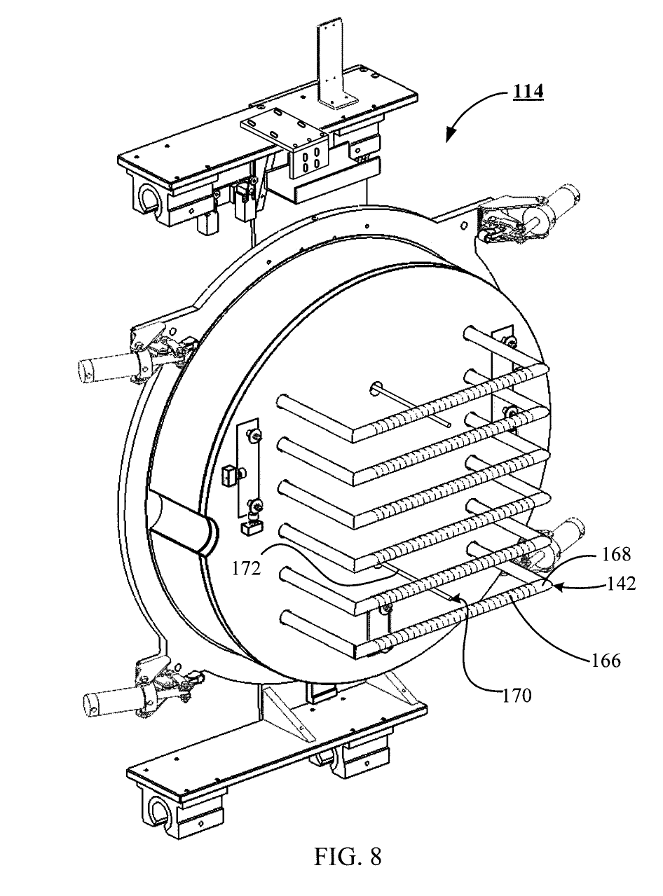

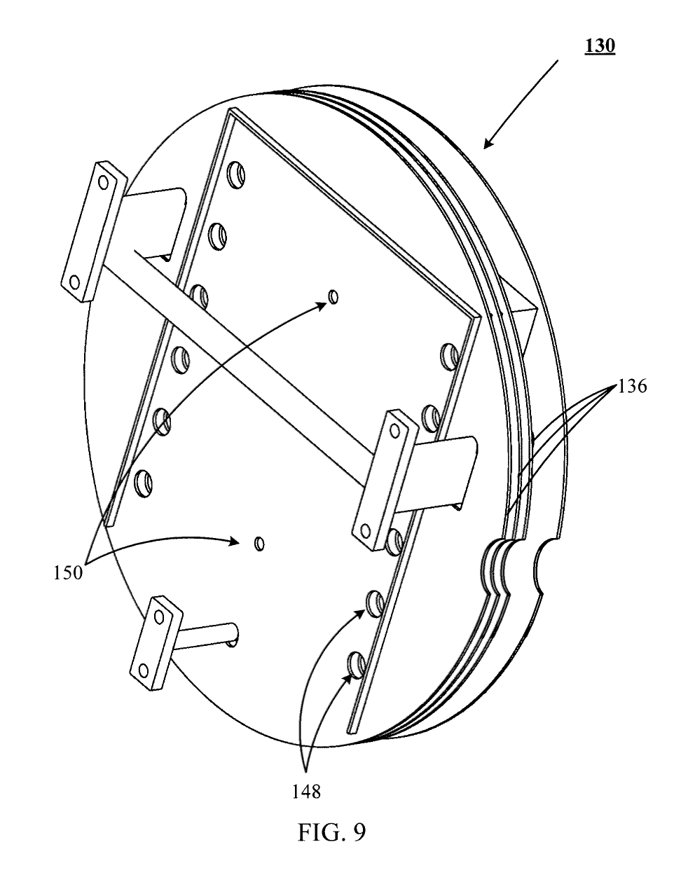

FIG. 8 provides a more detailed view of the plurality of preferred heat source devices 142 of the heat source door 114. In a preferred exemplary embodiment, each of the heat source lamps 142 includes a coiled heating element 166, which provides radiant thermal energy to the process chamber 106 of FIG. 1. Each of the coiled heating elements 166 are preferably enclosed quartz tube 168. FIG. 8 further shows that in a preferred embodiment of the heat source door 114 at least one thermal sensor 170, preferably enclosed by quartz tube 172. In an exemplary embodiment, the thermal sensor 170 is used to provide a closed loop control over the heat source lamps 142.

FIG. 9 provides a detailed view of the plurality of lamp pass-thru apertures 148 and the thermal sensor apertures 150 provided by the radiation reflection plates 136 of the exemplary thermal dispersion assembly 130.

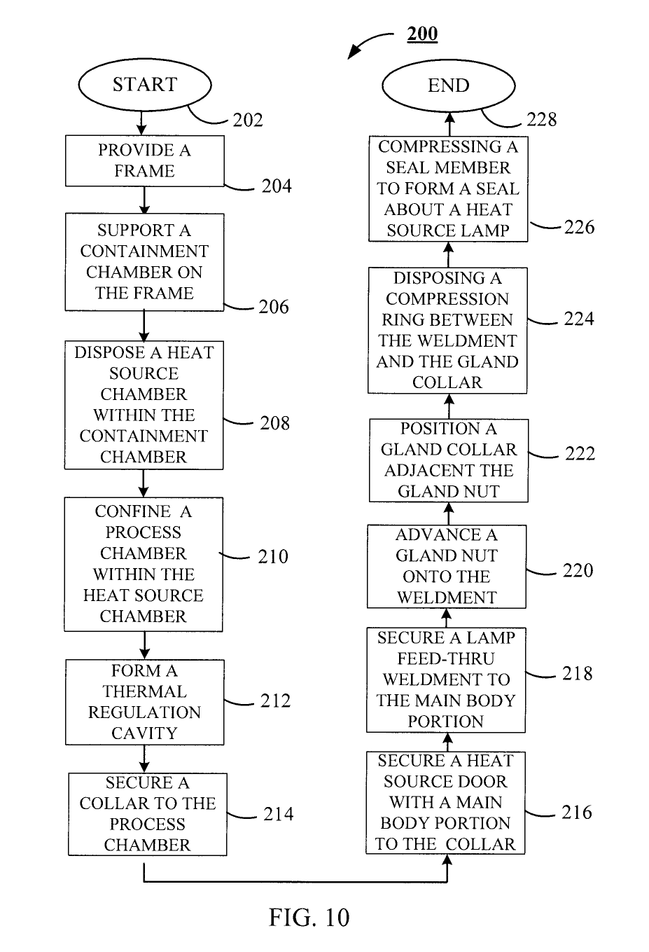

FIG. 10 provides an exemplary method of making a thermal chamber 200 conducted in accordance with various embodiments of the present invention. The method 200 of making a thermal diffusion chamber (such as 100) commences at start process step 202 and continues with process step 204. At process step 204, a frame (such as 104) is provided. At process step 206, a containment chamber (such as 102) is supported and secured to the frame. At process step 208, a heat source module (such as 108) is disposed within and confined by the containment chamber. At process step 210, a process chamber (such as 106) is confined within the heat source module. Preferably, the process chamber includes at least an interior surface and an exterior surface.

At process step 212, a thermal regulation cavity (such as 110) is formed between the heat source module and the process chamber, to provide an ability to regulate the process chamber. At process step 214, a collar (such as 112) is preferably secured to the containment chamber in fluidic communication with the interior of the process chamber.

At process step 216, a heat source door (such as 114), which preferably provides a main body portion (such as 118), is secured to the frame during non-operating modes of the thermal diffusion chamber, and is additionally secured to the collar during operating modes of the thermal diffusion chamber. At process step 218, a lamp feed-through weldment is secured to the main body portion, and at process step 220 a gland nut is advanced onto the weldment.

At process step 222, a gland collar is positioned adjacent the gland nut, wherein the gland collar is preferably responsive to an advancement of the gland nut. At process step 224, a compression ring is disposed between the weldment and the gland collar. At process step 226, a seal member disposed between the compression ring and the weldment and interacting with the heat source device is compressed to form a seal in response to a compressive load being applied to the seal member by the compression ring, and the process concludes at end process step 228.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present claimed invention to the full extent indicated by the broad general meaning of the terms in which the appended claims are expressed. For example, the particular elements may vary depending on the particular application without departing from the spirit and scope of the present claimed invention.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed by the appended claims.

What is claimed is:

1. A thermal diffusion chamber comprising:
a frame supporting a containment chamber;
a process chamber confined within the containment chamber;
a heat source module disposed between the containment chamber and the process chamber;
a collar communicating with the process chamber and secured to the containment chamber; and
a heat source door in fluidic communication with the process chamber, the heat source door comprising:
a top hat section secured to a main body portion;
an over center latch secured to the top hat section and interacting with the collar, the over center latch mitigates an inadvertent opening of the process chamber; and
a lamp feed-through secured to the main body portion and supports a heat source device.

2. The thermal diffusion chamber of claim 1, in which the main body portion of the heat source door comprising a stand-off secured to the top hat and a face plate secured to the stand-off.

3. The thermal diffusion chamber of claim 2, in which the heat source door further comprising a lamp support secured to the face plate.

4. The thermal diffusion chamber of claim 3, in which the heat source door further comprising a thermal dispersion assembly supported by the lamp support, wherein the lamp support provides alignment notches which interact with the thermal dispersion assembly to align the thermal dispersion assembly with the lamp support.

5. The thermal diffusion chamber of claim 4, in which the thermal dispersion assembly comprising a radiation reflection plate and a diffuser plate, in which the radiation reflection plate and the diffuser plate each provide a heat source device pass-thru aperture.

6. The thermal diffusion chamber of claim 5, in which the heat source door further comprising a lamp support tree supported by the lamp support and disposed between the radiation reflection plate and the diffuser plate.

7. The thermal diffusion chamber of claim 6, in which the heat source device comprising an element enclosed by a confinement conduit.

8. The thermal diffusion chamber of claim 7, in which the lamp support, the radiation reflection plate, the diffuser plate, and the confinement conduit are each formed from a mineral.

9. The thermal diffusion chamber of claim 8, in which the mineral is quartz.

10. The thermal diffusion chamber of claim 4, in which the lamp feed-through comprising:
a lamp feed-through weldment secured to the main body portion;
a gland nut communicating with the weldment;
a gland collar responsive to the gland nut;
a compression ring disposed between the weldment and the gland collar; and
a seal member disposed between the compression ring and the weldment interacting with the heat source device to form a seal in response to a compressive load being applied to the seal member by the compression ring.

11. A method of forming a thermal diffusion chamber by steps comprising:
providing a frame;
supporting a containment chamber on the frame;
disposing a heat source module within the containment chamber;
confining a process chamber within the heat source module;
forming a thermal regulation cavity disposed between the heat source module and the process chamber;
securing a collar to the process chamber; and
securing at least one heat source door to the collar and in fluidic communication with the process chamber, in which the heat source door includes at least:
a top hat section secured to a main body portion;
an over center latch secured to the top hat section and interacting with the collar, the over center latch mitigates an inadvertent opening of the process chamber; and
a lamp feed-through secured to the main body portion and supporting a heat source device.

12. The method of claim 11, in which the heat source door further comprising a face plate secured to the main body portion.

13. The method of claim 12, in which the heat source door further comprising a lamp support secured to the face plate.

14. The method of claim 13, in which the heat source door further comprising a thermal dispersion assembly supported by the lamp support, wherein the lamp support provides alignment notches which interact with the thermal dispersion assembly to align the thermal dispersion assembly with the lamp support.

15. The method of claim 14, in which the thermal dispersion assembly comprising a radiation reflection plate and a diffuser plate, in which the radiation reflection plate and the diffuser plate each provide a heat source device pass-thru aperture.

16. The method of claim 15, in which the heat source door further comprising a lamp support tree supported by the lamp support and disposed between the radiation reflection plate and the diffuser plate.

17. The method of claim 16, in which the heat source device comprising an element enclosed by a confinement conduit.

18. The method of claim 17, in which the lamp support, the radiation reflection plate, the diffuser plate, and the confinement conduit are each formed from a mineral.

19. The method of claim 18, in which the mineral is quartz.

20. The method of claim 14, by steps further comprising:
securing a lamp feed-through weldment to the main body portion;
advancing a gland nut onto the weldment;
positioning a gland collar responsive to the gland nut adjacent the gland nut;
disposing a compression ring between the weldment and the gland collar; and
compressing a seal member disposed between the compression ring and the weldment interacting with the heat source device to form a seal in response to a compressive load being applied to the seal member by the compression ring.
